(19) United States
(12) Patent Application Publication
(10) Pub. No.: US 2003/0107360 A1
(43) Pub. Date: Jun. 12, 2003

(54) Low power bandgap circuit

(76) Inventors: Ionel Gheorghe, Ottawa (CA); Florinel G. Balteanu, Ottawa (CA)

Correspondence Address: Scott A. Horstemeyer, THOMAS, KAYDEN, HORSTEMEYER, & RISLEY, L.L.P., 100 Galleria Parkway, N.W., Suite 1750, Atlanta, GA, 30339-5948, US

(21) Appl. No.: 10/008,442

(22) Filed: Dec. 6, 2001

(51) Int. Cl. G05F 3/16

(52) U.S. Cl. 323/313

(57) ABSTRACT

A bandgap reference circuit for generating a reference voltage includes a transistor, a bias current source for generating a bias current, a proportional to absolute temperature (PTAT) current source for generating a PTAT current, a first resistor, and a second resistor. The transistor generates a base-emitter voltage that is divided at an output node through the first and second resistors. The first resistor couples between the collector of the transistor and the output node. The second resistor couples between the output node and ground. The bias current source supplies the bias current to the transistor and the PTAT current source supplies a PTAT current to output node 105. The reference voltage may be obtained at output node as a result of combining a portion of the base-emitter voltage, which has a negative temperature coefficient, with a PTAT voltage that is obtained by sensing a portion of the PTAT current over the second resistor.

### BACKGROUND OF THE INVENTION

1. Field of the Invention

The present invention relates to reference voltage circuits and, in particular, to a bandgap reference voltage circuit characterized by low power consumption.

2. Related Art

Portable wireless systems have increased the demand for analog circuits which are powered by a low voltage source. Most of these analog circuits use a bandgap reference circuit that generates a constant voltage by summing two currents or voltages, one that is proportional to absolute temperature (PTAT) and another that is complementary to absolute temperature (CTAT). The sum of these currents or voltages can be temperature independent and can be used to obtain a reference voltage, usually referred to as a bandgap reference voltage. This technique usually requires a relatively high power supply voltage of approximately 2.5V-3.3V and a power supply current of about 100 μA. Examples of bandgap reference circuits are described in Widlar, “A new breed of linear ICs run at 1-volt levels,” Electronics, Mar. 29, 1979, pp. 115-119, and Brokaw, “A simple three terminal IC bandgap reference,” IEEE Journal of Solid-State Circuits, 1974, SC-9 (6), pp.667-670.

Recently, various techniques have been proposed for designing reference voltage circuits that provide precise reference voltages and that operate at low supply voltages. A main emphasis in designing such circuits has been reducing the reference voltage and the power consumption. Such circuit design techniques are described in the following articles: Vittoz et al., “A Low-Voltage CMOS Bandgap Reference,” IEEE Journal Of Solid-State Circuits, 1979, SC-14, No. 3, pp.573-577; Gunawan et al., “A Curvature-Corrected Low-Voltage Bandgap Reference,” IEEE Journal Of Solid State Circuits, 1993, Vol. 28, No. 6, pp.667-670; Jiang et al., “Design Of Low-Voltage Bandgap Reference Using Transimpedance Amplifier,” IEEE Transactions On Circuits And Systems-II: Analog And Digital Signal Processing, 2000, Vol.47, No. 6, pp.667-670; Banba et al., “A CMOS Bandgap Reference Circuit With Sub-1-V Operation,” IEEE Journal Of Solid-State Circuits, 1999, Vol. 34, No. 5, pp.670-674. None of these references, however, disclose a reference voltage circuit that is simple and cost effective, and that has very low power consumption. Therefore, what is needed is a simple and cost effective circuit that provides a precise reference voltage and that has very low power consumption.

### SUMMARY

In one embodiment of the present invention, a bandgap reference circuit includes a bias current source, a transistor, a first resistor, a second resistor, and a proportional to absolute temperature (PTAT) current source. The transistor has an emitter, a collector, and a base. The collector is coupled to the bias current source and to the first resistor. The first resistor is coupled between the collector and the second resistor. The PTAT current source provides a PTAT current to an output node between the first resistor and the second resistor.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a schematic diagram illustrating a bandgap reference circuit for generating a reference voltage V_{ref} in accordance with one embodiment of the invention.

FIG. 1B is a schematic diagram illustrating a bandgap reference circuit that is an alternative embodiment to the bandgap reference circuit illustrated in FIG. 1A.

FIG. 2 is a schematic diagram of a bandgap reference circuit illustrating one possible approach for generating the bias current and the proportional to absolute temperature (PTAT) current depicted in FIGS. 1A and 1B.

FIG. 3 is a graph depicting variations in the reference voltage V_{ref} and in the power supply current I_{dd} for a bandgap reference circuit using a voltage source V_{dd} equal to 1.0V.

FIG. 4 is a graph depicting variations in the reference voltage V_{ref} and in the power supply current I_{dd} for a bandgap reference circuit using a voltage source V_{dd} equal to 1.2V.

FIG. 5 is a block diagram illustrating a non-limiting example of a simplified portable transceiver in which an embodiment of the invention may be implemented.

### DETAILED DESCRIPTION

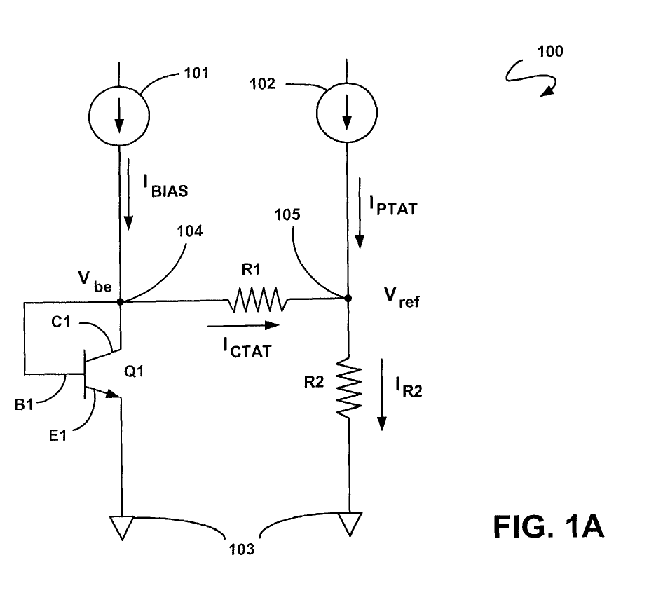

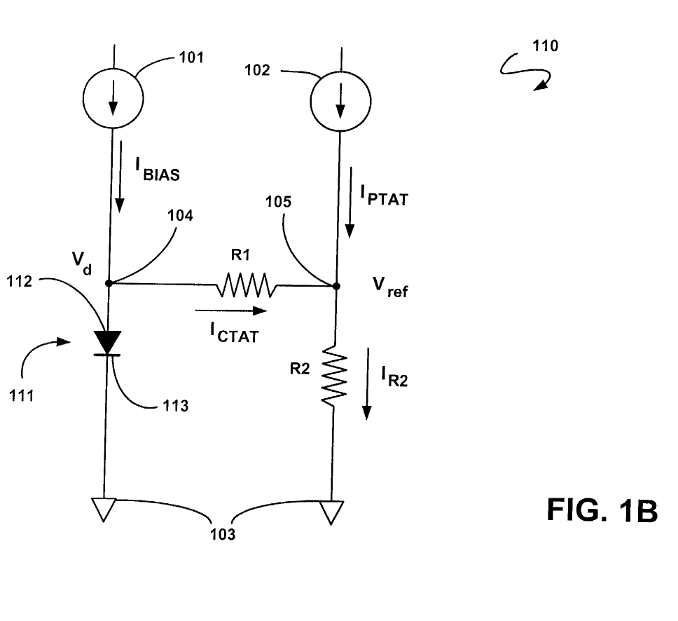

FIG. 1A is a schematic diagram illustrating a bandgap reference circuit 100 for generating a reference voltage V_{ref} in accordance with one embodiment of the invention. Circuit 100 includes a transistor Q1, a bias current source 101 for generating a bias current I_{BIAS}, a proportional to absolute temperature (PTAT) current source 102 for generating a PTAT current I_{PTAT}, a first resistor R1, and a second resistor R2. Transistor Q1, which can be any type of bipolar transistor (e.g. pnp or npn), has a base terminal B1, a collector terminal C1, and an emitter terminal E1. Base terminal B1 is coupled to collector terminal C1, whereas emitter terminal E1 is coupled to ground 103. Transistor Q1 generates a base-emitter voltage (V_{be}) that is divided at output node 105 through resistors R1 and R2. Resistor R1 couples between the terminal C1 and output node 105. Resistor R2 couples between output node 105 and ground 103. Bias current source 101 supplies bias current I_{BIAS} to terminals B1 and C1, and current source 102 supplies PTAT current I_{PTAT} to output node 105.

The voltage V_{be} causes a CTAT current I_{CTAT} to flow from node 104 to node 105. The current I_{CTAT} and a portion of current I_{PTAT} combine to form a current I_{R2} which flows through resistor R2 to generate reference voltage V_{ref} at output node 105. The reference voltage V_{ref} is therefore made up of two components: a CTAT voltage V_{CTAT} that is proportional to V_{be} and a PTAT voltage V_{PTAT} that is proportional to I_{PTAT}. The value for the reference voltage V_{ref} can be determined as follows:

$$\begin{matrix}{V}_{ref} = {V}_{CTAT} + {V}_{PTAT} \\ = \frac{R2}{R1 + R2} \cdot {V}_{be} + \frac{R1 \cdot R2}{R1 + R2} \cdot {I}_{PTAT}\end{matrix} \qquad ( EQ . 1 )$$

By choosing suitable values for resistors R1 and R2 and for the PTAT current I_{PTAT}, the reference voltage V_{ref} can be maintained at a substantially constant level regardless of variations in the temperature of the circuit.

FIG. 1B is a schematic diagram illustrating a bandgap reference circuit 110 that is an alternative embodiment to the bandgap reference circuit 100 illustrated in FIG. 1A. Circuit 110 includes a diode 111 having an anode 112 that is coupled to bias current source 101, and a cathode 113 that is coupled to ground 103. Resistor RI couples between anode 112 and output node 105. Resistor R2 couples between output node 105 and ground 103. Current source 101 supplies bias current I_{BIAS} to anode 112, and current source 102 supplies PTAT current I_{PTAT} to output node 105. Diode 111 generates a diode voltage V_{d} that causes a CTAT current I_{CTAT} to flow from node 104 to node 105. The current I_{CTAT} and a portion of the current I_{PTAT} combine to form a current I_{R2} that flows through resistor R2 thereby generating reference voltage V_{ref} at output node 105. The value for the reference voltage V_{ref} can be determined as follows:

$${V}_{ref} = \frac{R2}{R1 + R2} \cdot {V}_{d} + \frac{R1 \cdot R2}{R1 + R2} \cdot {I}_{PTAT} \qquad ( EQ . 2 )$$

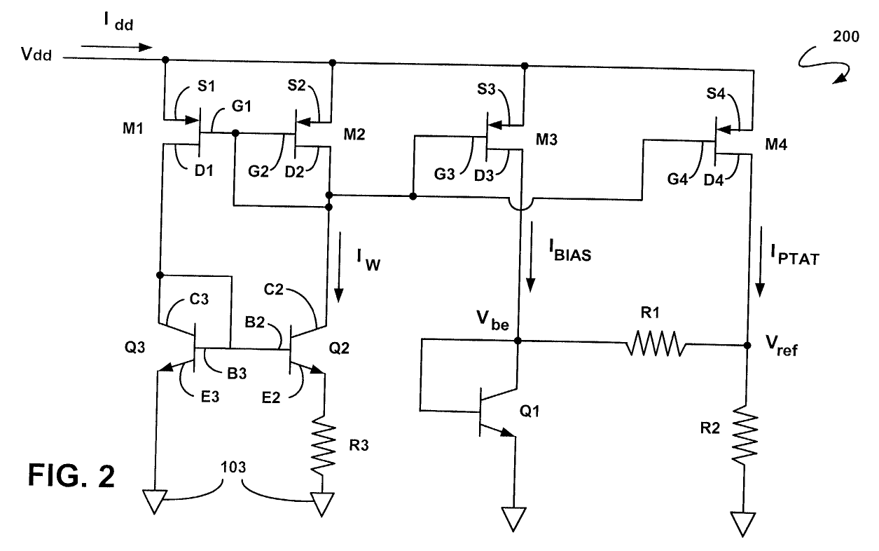

FIG. 2 is a schematic diagram of a bandgap reference circuit 200 illustrating one possible approach for generating currents I_{BIAS} and I_{PTAT}. The bandgap reference circuit 200 has relatively few components and is suitable for large-scale integration. Those having ordinary skill in the art will appreciate that other approaches may also be used to generate currents I_{BIAS} and I_{PTAT}. The bandgap reference circuit 200 includes resistors R1, R2, and R3 and transistors M1, M2, M3, M4, Q1, Q2, and Q3. Transistors M1, M2, M3, and M4 comprise respective gate terminals G1, G2, G3, and G4, respective source terminals S1, S2, S3, and S4, and respective drain terminals D1, D2, D3, and D4. Transistors Q2 and Q3 comprise respective base terminals B2 and B3, respective emitter terminals E2 and E3 and respective collector terminals C2 and C3. Each of transistors M1 through M4 is preferably a positive channel metal-oxide-semiconductor field-effect transistor (p-channel MOSFET), but may, in an alternative embodiment, be replaced with any suitable transistor such as, for example, a bipolar transistor. Transistors Q1, Q2, and Q3, on the other hand, are preferably bipolar transistors, although transistors Q1 and Q3 may be replaced with bipolar diodes. The base terminal B3 is coupled to the collector terminal C3, to base terminal B2, and to drain terminal D1. Resistor R3 couples between emitter terminal E2 and ground 103. Gate terminals G1, G2, G3, and G4 are coupled to one another, to collector terminal C2, and to drain terminal D2. Source terminals S1, S2, S3, and S4 are coupled to one another and to a voltage source V_{dd} that provides a supply current I_{dd}. Other components such as transistor Q1, resistor R1, and resistor R2 are coupled as described above with reference to FIG. 1A.

Transistors Q2 and Q3 create a Widlar PTAT current I_{W} The value of the current I_{W} can be determined as follows:

$${I}_{W} = \frac{k \cdot T}{q \cdot R3} \cdot ln \frac{A2}{A3} \qquad ( EQ . 3 )$$

where k=Boltzmann's constant, T=absolute temperature in ° K, q=the charge of an electron, A2 is the interface area between the emitter terminal and the base terminal of transistor Q2, and A3 is the interface area between the emitter terminal and the base terminal of transistor Q3. The value of kT/q is commonly referred to as the thermal voltage VT and is temperature dependant. Transistors M2, M3, and M4 act as a current mirror that produces currents I_{BIAS} and I_{PTAT}. Currents I_{BIAS} and I_{PTAT} are related to current I_{W} as follows:

$$\begin{matrix}{I}_{PTAT} = {I}_{W} \cdot \frac{W4 \cdot L2}{W2 \cdot L4} & ( EQ . 4 ) \\ {I}_{BIAS} = {I}_{W} \cdot \frac{W3 \cdot L2}{W2 \cdot L3} & ( EQ . 5 )\end{matrix}$$

The terms W2, W3, and W4 represent the widths of gate terminals G2, G3, and G4, respectively, and the terms L2, L3, and L4 represent the lengths of gate terminals G2, G3, and G4, respectively.

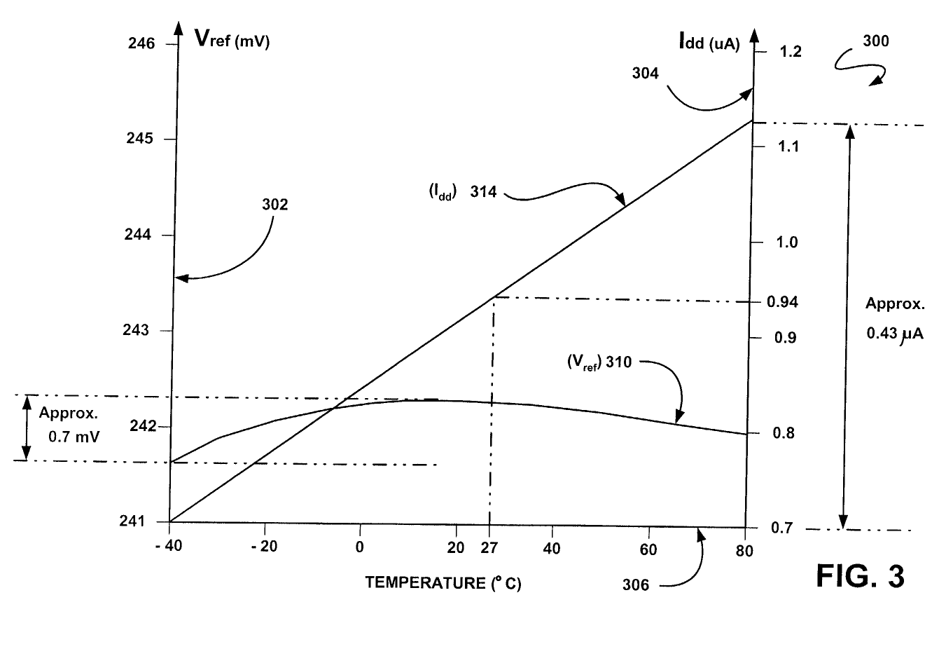

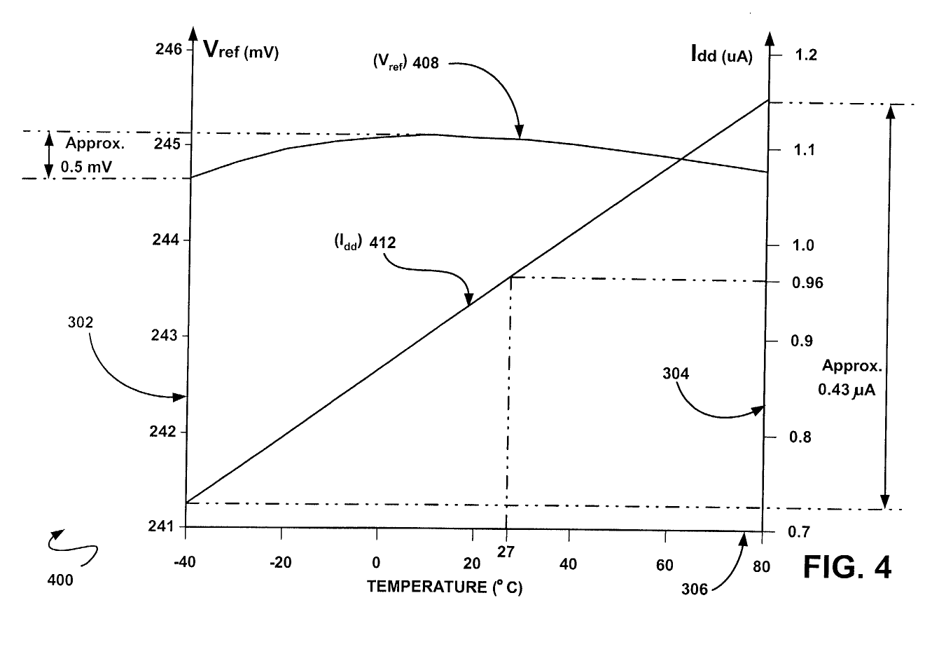

FIGS. 3 and 4 are graphical illustrations collectively depicting non-limiting examples of simulations for bandgap reference circuit 200 (FIG. 2), where transistors Q1, Q2, and Q3 are silicon-germanium (SiGe) bipolar transistors. These graphical illustrations show that the bandgap reference circuit 200 can provide a reference voltage V_{ref} that is substantially constant in response to variations in temperature, while drawing a supply current I_{dd} of less than 1 μA. It should be emphasized that in alternative embodiments of the invention, each of the transistors Q1, Q2, and Q3 may be any suitable type of bipolar transistor.

FIG. 3 is a graphical illustration 300 depicting variations in the reference voltage V_{ref} and in the supply current I_{dd} for a bandgap reference circuit 200 using a voltage source V_{dd} equal to 1.0V. The first vertical axis 302 represents the output voltage V_{ref} in mV, the second vertical axis 304 represents the supply current I_{dd} in μA and the horizontal axis 306 represents the circuit temperature in ° C. The line segment 310 represents a plot of the output voltage V_{ref} and the line segment 314 represents a plot of the supply current I_{dd}. As shown in FIG. 3, the simulated reference voltage V_{ref} varies by about 0.7 mV and the simulated supply current I_{dd} varies by about 0.43 μA over a temperature range of −40° C. to 80° C. At a temperature of approximately 27° C. (room temperature), circuit 200 draws a supply current I_{dd} of about 0.94 μA from a voltage source V_{dd} equal to 1.0V. Therefore, the amount of power consumed at room temperature is only about 0.94 μW (0.94 μA times 1.0V).

FIG. 4 is a graphical illustration 400 depicting variations in the reference voltage V_{ref} and in the supply current I_{dd} for a bandgap reference circuit 200 using a voltage source V_{dd} equal to 1.2V. Line segments 408 and 412 represent plots of the output voltage V_{ref} and the supply current I_{dd}, respectively, over temperature. As shown in FIG. 4, the simulated reference voltage V_{ref} varies by about 0.5 mV and the simulated supply current I_{dd} varies by about 0.43 μA over a temperature range of −40° C. to 80° C. At a temperature of 27° C., circuit 200 draws a supply current I_{dd} of about 0.96 μA. Therefore, the amount of power consumed at room temperature is only about 1.15 μW (0.96 μA times 1.2V).

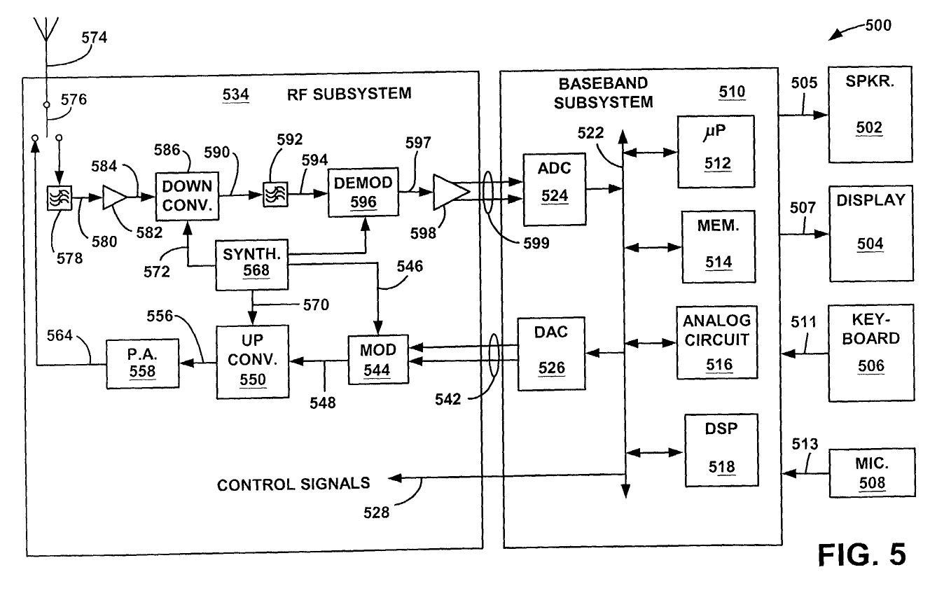

FIG. 5 is a block diagram illustrating a non-limiting example of a simplified portable transceiver 500 in which embodiments of the bandgap reference circuits 100, 110, and 200 (FIGS. 1A, 1B, and 2) may be implemented. The bandgap reference circuit 100 may be used to provide a voltage V_{ref} to many of the components of transceiver 500 including, for example, analog-to-digital converter 524, digital-to-analog converter 526, modulator 544, upconverter 550, synthesizer 568, power amplifier 558, receive filter 578, low noise amplifier 582, downconverter 586, channel filter 592, demodulator 596, and amplifier 598. It should be emphasized that systems and methods of the invention are not limited to the portable transceiver 500 or to wireless communications devices. Other devices that may incorporate an embodiment of the invention include, for example, dynamic random access memories (DRAMs).

The portable transceiver 500 includes speaker 502, display 504, keyboard 506, and microphone 508, all connected to baseband subsystem 510. In a particular embodiment, the portable transceiver 500 can be, for example, but not limited to, a portable telecommunication handset such as a mobile cellular-type telephone. Speaker 502 and display 504 receive signals from baseband subsystem 510 via connections 505 and 507, respectively. Similarly, keyboard 506 and microphone 508 supply signals to baseband subsystem 510 via connections 511 and 513, respectively. Baseband subsystem 510 includes microprocessor (μP) 512, memory 514, analog circuitry 516 and digital signal processor (DSP) 518, each coupled to a data bus 522. Data bus 522, although shown as a single bus, may be implemented using multiple busses connected as necessary among the subsystems within baseband subsystem 510. Microprocessor 512 and memory 514 provide signal timing, processing and storage functions for portable transceiver 500. Analog circuitry 516 provides the analog processing functions for the signals within baseband subsystem 510. Baseband subsystem 510 provides control signals to radio frequency (RF) subsystem 534 via connection 528. Although shown as a single connection 528, the control signals may originate from DSP 518 or from microprocessor 512, and may be supplied to a variety of points within RF subsystem 534. It should be noted that, for simplicity, only selected components of a portable transceiver 500 are illustrated in FIG. 5.

Baseband subsystem 510 also includes analog-to-digital converter (ADC) 524 and digital-to-analog converter (DAC) 526. ADC 524 and DAC 526 communicate with microprocessor 512, memory 514, analog circuitry 516 and DSP 518 via data bus 522. DAC 526 converts digital communication information within baseband subsystem 510 into an analog signal for transmission to RF subsystem 534 via connection 542.

RF subsystem 534 includes modulator 544, which, after receiving an LO signal from synthesizer 568 via connection 546, modulates the received analog information and provides a modulated signal via connection 548 to upconverter 550. Upconverter 550 also receives a frequency reference signal from synthesizer 568 via connection 570. Synthesizer 568 determines the appropriate frequency to which upconverter 550 will upconvert the modulated signal on connection 548.

Upconverter 550 supplies a phase-modulated signal via connection 556 to power amplifier 558. Power amplifier 558 amplifies the modulated signal on connection 556 to the appropriate power level for transmission via connection 564 to antenna 574. Illustratively, switch 576 controls whether the amplified signal on connection 564 is transferred to antenna 574 or whether a received signal from antenna 574 is supplied to filter 578. The operation of switch 576 is controlled by a control signal from baseband subsystem 510 via connection 528. Alternatively, the switch 576 may be replaced with circuitry to enable the simultaneous transmission and reception of signals to and from antenna 574.

A signal received by antenna 574 will, at the appropriate time determined by baseband system 510, be directed via switch 576 to a receive filter 578. Receive filter 578 filters the received signal and supplies the filtered signal on connection 580 to low noise amplifier (LNA) 582. Receive filter 578 is a bandpass filter, which passes all channels of the particular cellular system in which the portable transceiver 500 is operating. As an example, for a Global System For Mobile Communications (GSM) 900 MHz system, receive filter 578 would pass all frequencies from 935.1 MHz to 959.9 MHz, covering all 524 contiguous channels of 200 kHz each. The purpose of this filter is to reject all frequencies outside the desired region. LNA 582 amplifies the weak signal on connection 580 to a level at which downconverter 586 can translate the signal from the transmitted frequency back to a baseband frequency. Alternatively, the functionality of LNA 582 and downconverter 586 can be accomplished using other elements, such as for example but not limited to, a low noise block downconverter (LNB).

Downconverter 586 receives an LO signal from synthesizer 568, via connection 572. The LO signal is used in the downconverter 586 to downconvert the signal received from LNA 582 via connection 584. The downconverted frequency is called the intermediate frequency (“IF”). Downconverter 586 sends the downconverted signal via connection 590 to channel filter 592, also called the “IF filter.” Channel filter 592 filters the downconverted signal and supplies it via connection 594 to demodulator 596. The channel filter 592 selects one desired channel and rejects all others. Using the GSM system as an example, only one of the 524 contiguous channels would be selected by channel filter 592. The synthesizer 568, by controlling the local oscillator frequency supplied on connection 572 to downconverter 586, determines the selected channel. Demodulator 596 recovers the transmitted analog information and supplies a signal representing this information via connection 597 to amplifier 598. Amplifier 598 amplifies the signal received via connection 597 and supplies an amplified signal via connection 599 to ADC 524. ADC 524 converts these analog signals to a digital signal at baseband frequency and transfers it via data bus 522 to DSP 518 for further processing.

While various embodiments of the invention have been described, it will be apparent to those of ordinary skill in the art that many more embodiments and implementations are possible that are within the scope of this invention.

What is claimed is:

1. A bandgap reference circuit comprising:
a transistor having an emitter, a collector, and a base;
a first resistor and a second resistor, where the first resistor is coupled between the collector and the second resistor;
a proportional to absolute temperature (PTAT) current source for providing a PTAT current, where the PTAT current source is coupled to a node between the first resistor and the second resistor;
where a reference voltage is generated at the node between the first resistor and the second resistor.

2. The bandgap reference circuit of claim 1, further comprising:
a bias current source for providing a bias current to the transistor.

3. The bandgap reference circuit of claim 1, where the base is coupled to the collector.

4. The bandgap reference circuit of claim 3, where the second resistor couples between the first resistor and ground.

5. The bandgap reference circuit of claim 4, where the emitter is coupled to ground.

6. The bandgap reference circuit of claim 1, where the reference voltage remains substantially constant in response to variations in temperature.

7. The bandgap reference circuit of claim 1, where the transistor is a bipolar transistor.

8. The bandgap reference circuit of claim 7, where the bipolar transistor comprises silicon and germanium.

9. The bandgap reference circuit of claim 1, where the bandgap reference circuit is part of a wireless communications device.

10. A method for providing a reference voltage, comprising:
providing a transistor having an emitter, a collector, and a base;
providing a first resistor and a second resistor, where the first resistor is coupled between the collector and the second resistor;
providing a proportional to absolute temperature (PTAT) current, where the PTAT current source is received by a node between the first resistor and the second resistor;
where a reference voltage is generated at the node between the first resistor and the second resistor.

11. The method of claim 10, further comprising:
providing a bias current to the transistor.

12. The method of claim 10, where the base is coupled to the collector.

13. The method of claim 12, where the second resistor couples between the first resistor and ground.

14. The method of claim 13, where the emitter is coupled to ground.

15. The method of claim 10, where the reference voltage remains substantially constant in response to variations in temperature.

16. The method of claim 10, where the transistor is a bipolar transistor.

17. The method of claim 16, where the bipolar transistor comprises silicon and germanium.

18. A method for providing a reference voltage, comprising:
providing a base-emitter voltage;
providing a first current that varies in proportion to the base-emitter voltage;
providing a second current that is proportional to absolute temperature (PTAT);
routing the first current and a portion of the second current through a second resistor thereby generating a reference voltage V_{ref} that is substantially constant in response to variations in temperature.

19. The method of claim 18, where:
the base-emitter voltage is provided by a transistor having an emitter, a collector, and a base;
a first resistor is coupled between the collector and the second resistor;
the PTAT current source is received by a node between the first resistor and the second resistor;
the reference voltage V_{ref} is generated at the node between the first resistor and the second resistor.

20. A bandgap reference circuit comprising:
a diode having an anode and a cathode;
a first resistor and a second resistor, where the first resistor is coupled between the anode and the second resistor;
a proportional to absolute temperature (PTAT) current source for providing a PTAT current, where the PTAT current source is coupled to a node between the first resistor and the second resistor;
where a reference voltage is generated at the node between the first resistor and the second resistor.

21. The bandgap reference circuit of claim 20, further comprising:
a bias current source for providing a bias current to the diode.

22. The bandgap reference circuit of claim 20, where the second resistor couples between the first resistor and ground.

23. The bandgap reference circuit of claim 20, where the emitter is coupled to ground.

24. The bandgap reference circuit of claim 20, where the reference voltage remains substantially constant in response to variations in temperature.
